(19) United States
(12) Patent Application Publication
(10) Pub. No.: US 2026/0196207 A1
(43) Pub. Date: Jul. 9, 2026

(54) SYSTEMS AND METHODS FOR PAYLOAD TRANSMISSION OVER A LOSSY NETWORK

(71) Applicant: WELLS FARGO BANK, N.A., San Francisco, CA (US)

(72) Inventors: Shannon Chang, Tucson, AZ (US); Christopher Barath, Chandler, AZ (US)

(21) Appl. No.: 19/012,004

(22) Filed: Jan. 7, 2025

(51) Int. Cl. G10L 13/08; G10L 15/26; H04L 43/0876

(52) U.S. Cl. CPC G10L 13/08; G10L 15/26; H04L 43/0876

(57) ABSTRACT

Systems and methods for interactive voice to text closed captioning are described. The systems and methods include receiving a voice seed and receiving voice input comprising an audio payload and a voiceprint. The systems and methods include detecting a bandwidth of a network or signal quality is under a first threshold and in response to detecting the bandwidth or signal quality is under the first threshold, converting the audio payload into a text payload comprising textual speech data that represents the audio payload. The text payload and/or the audio payload is transmitted over the network and output audio data is generated based in part on the text payload applied to the voice seed.

### FIELD OF INVENTION

The present disclosure generally relates to voice to text transcription and, and more specifically to systems and methods for payload transmission of over a lossy network as well as to interactive voice to text displays.

### BACKGROUND

Data transmission across a network is constrained by the network bandwidth. The network bandwidth in a live system is subject to fluctuations in capacity due to a variety of factors including network congestion, environmental factors, and physical characteristics of the communication channel. Such fluctuations in capacity directly affect the quality of data transmission and signal quality, resulting in poor signal delivery during periods of low bandwidth and high traffic across the network. Particularly, audio signals may be impaired in along with a speaker's ability to communicate over the network.

Voice to text services (i.e., transcription services) can provide means for converting audio speech input to text-based speech. Techniques for interacting with text-based speech are limited and prevent users from interacting with voice input from others, whether through received audio or through interactive interfaces. Particularly with respect to streaming services, voice to text transcription fails to provide a truly interactive experience to participating users.

### SUMMARY

According to certain examples, systems and method for interactive voice to text over a lossy network are described. The systems operations and methods include receiving a voice seed and receiving voice input comprising an audio payload and a voiceprint. The systems and methods include detecting a bandwidth of a network or signal quality is under a first threshold and in response to detecting the bandwidth is under the first threshold, converting the audio payload into a text payload comprising textual speech data that represents the audio payload. The text payload and/or the audio payload is transmitted over the network and output audio data is generated based in part on the text payload applied to the voice seed.

Another example relates to systems and methods for interactive voice to text closed captioning. The systems operations and methods include receiving a multi-media stream comprising audio content, visual content, and chat content and receiving a first multi-media input comprising an audio input or an image input. The first multi-media input is indexed in a time index and a selected index of one or more content indices. The first multi-media input is then converted into a text element that is representative of the first multi-media input and the text element displayed within the multi-media stream. The systems and methods include receiving a response input responsive to the text element and indexing the response input in the time index and the selected index.

In some examples, a non-transitory computer readable medium comprising instructions that, when executed by one or more processors, cause the one or more processors execute the methods and operations described above.

These illustrative aspects and features are mentioned not to limit or define the presently described subject matter, but to provide examples to aid understanding of the concepts described in this application. Other aspects, advantages, and features of the presently described subject matter will become apparent after review of the entire application.

### BRIEF DESCRIPTION

A full and enabling disclosure is set forth more particularly in the remainder of the specification. The specification makes reference to the following appended figures.

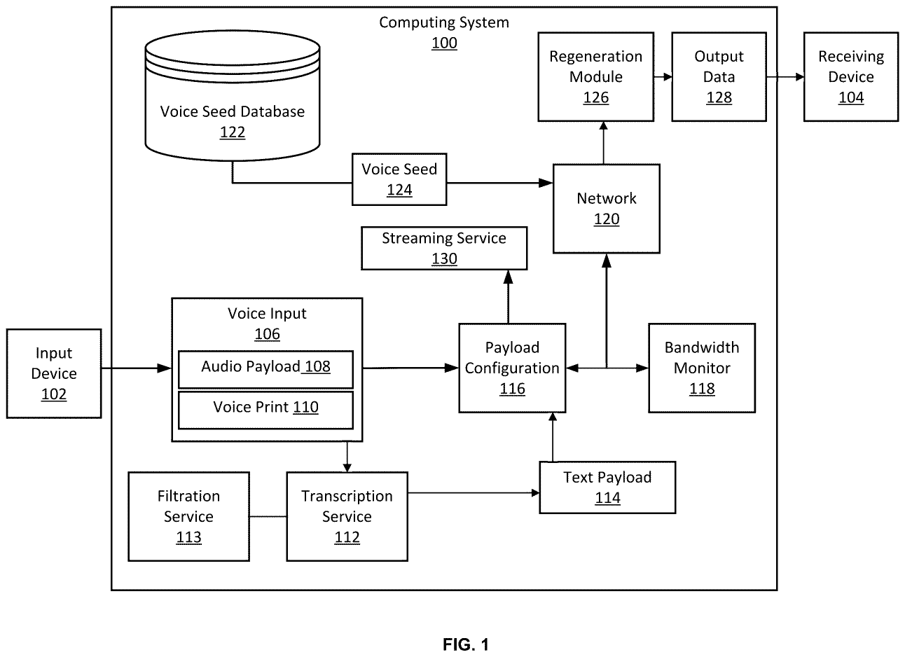

FIG. 1 illustrates a system for transmitting audio and/or textual payloads across a lossy network, according to certain embodiments.

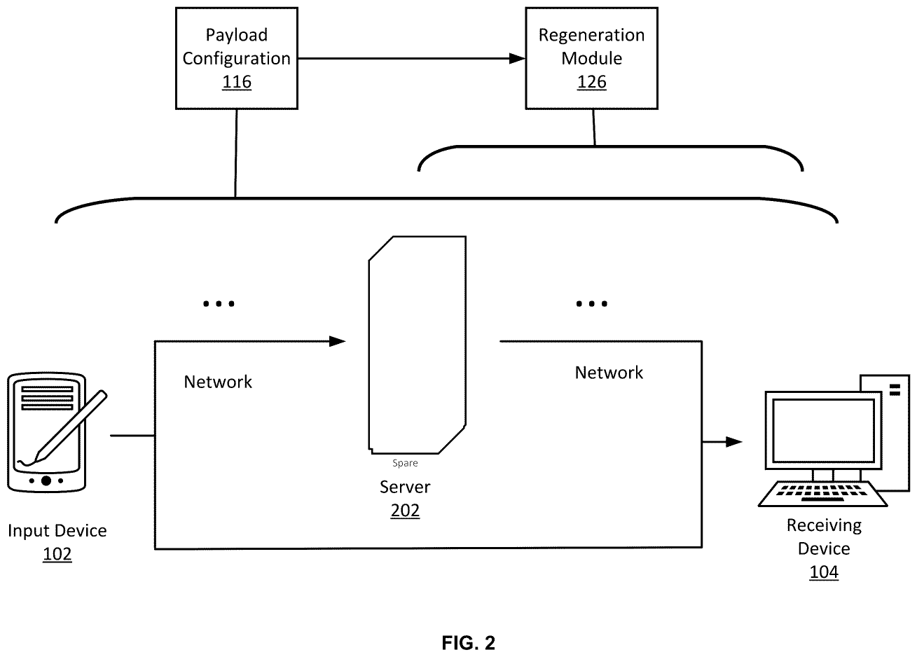

FIG. 2 shows an example system illustrating various implementations of payload transmissions across multiple networks, according to certain embodiments.

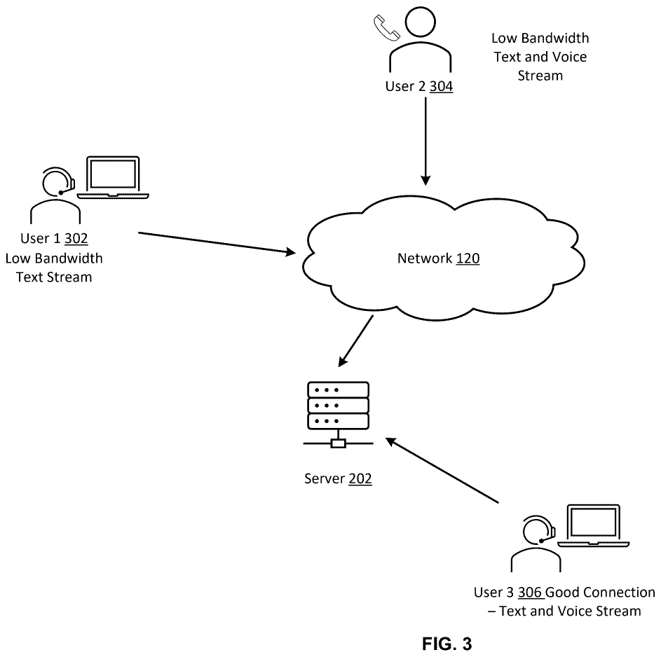

FIG. 3 shows an example system illustrating various payload configurations transmitted across lossy networks, according to certain embodiments.

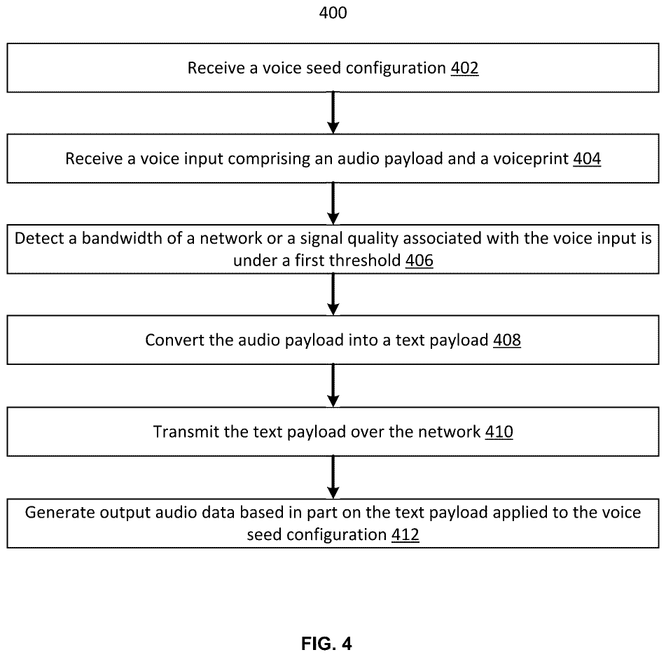

FIG. 4 shows an example process for configuring payloads for transmission across a network according to certain embodiments.

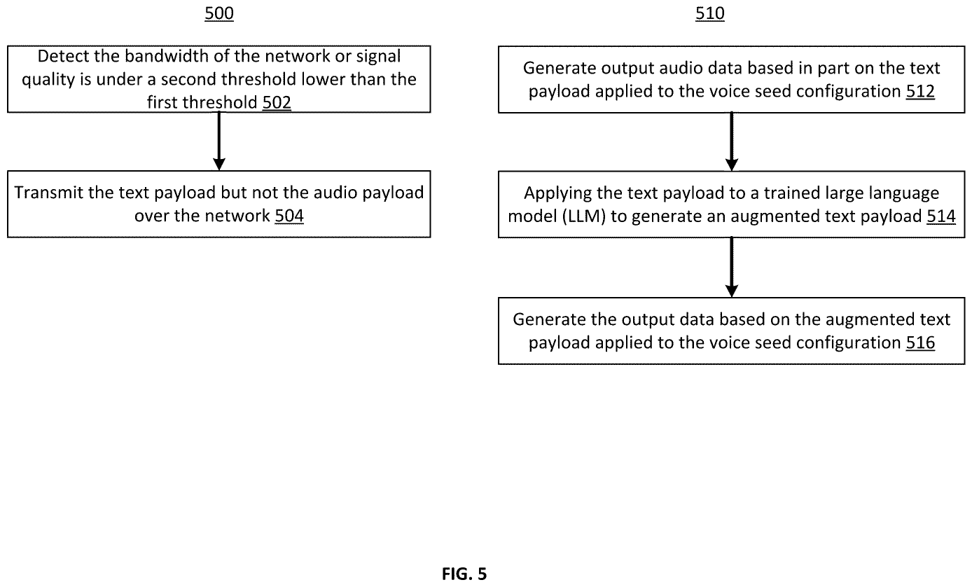

FIG. 5 shows a further example processes for configuring payloads for transmission across a network according to certain embodiments.

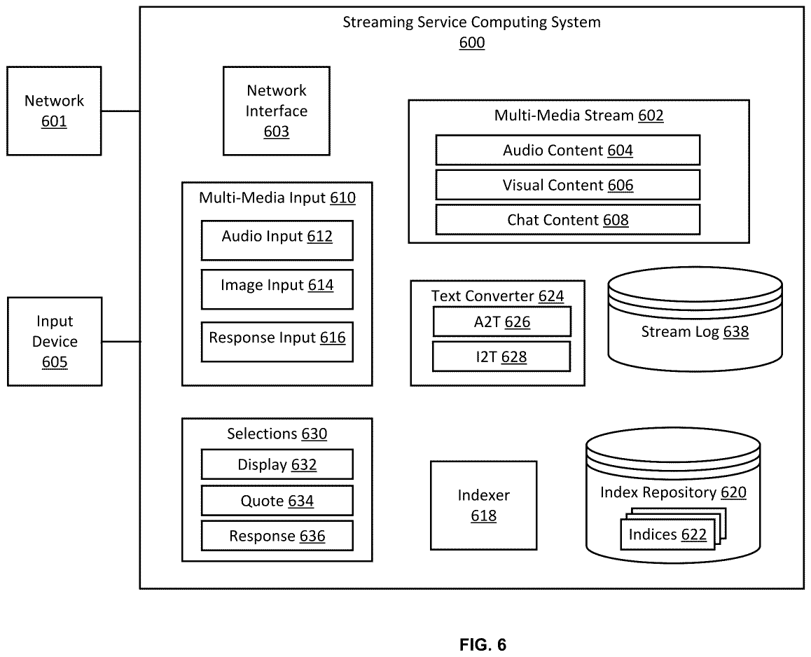

FIG. 6 shows a system for interacting with a multi-media stream with multi-media input such as audio input including voice and visual input including images according to certain embodiments.

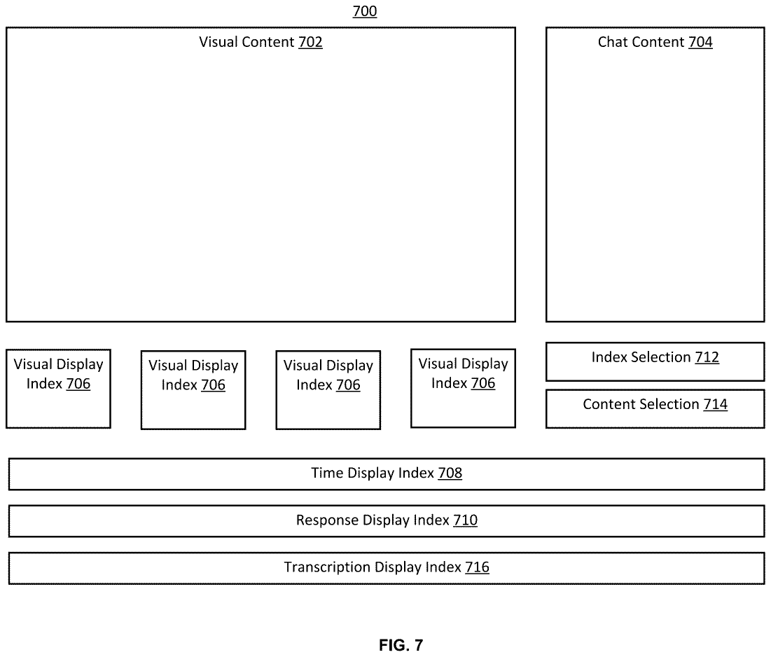

FIG. 7 shows an example interface for interacting with multi-media streams, according to certain embodiments.

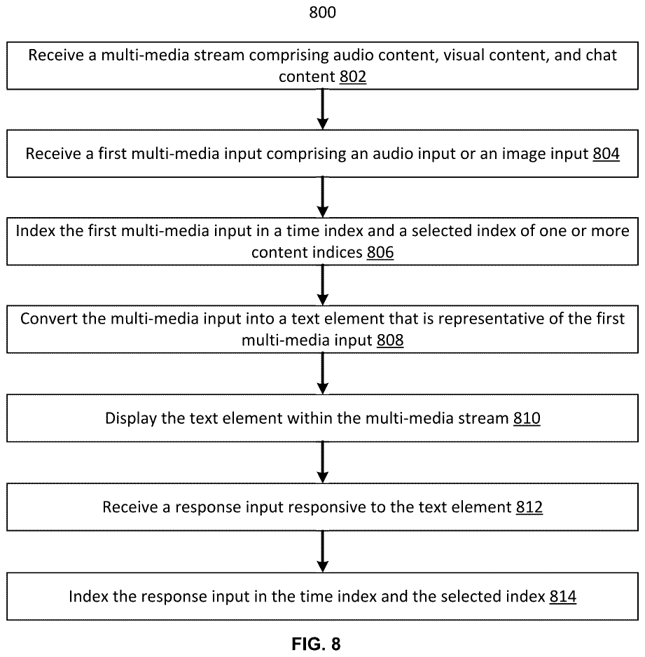

FIG. 8 shows an example process for interacting with a multi-media stream according to certain embodiments.

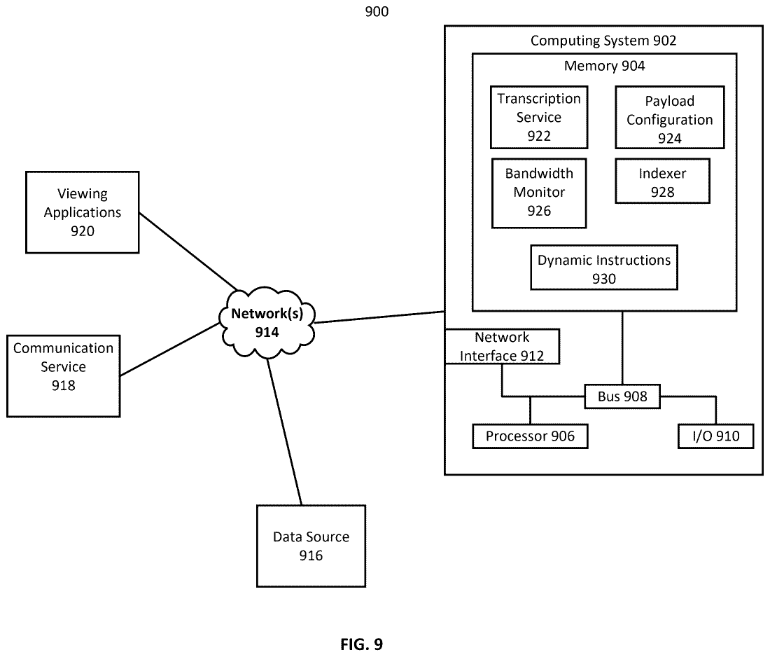

FIG. 9 shows a block diagram for an example computing environment capable of executing the described systems and methods, according to certain embodiments.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Example of Lossy Network Transmission

In one illustrative example, a system for lossy network transmission is described which is capable of overcoming the above described issues related to transmission of data such as voice data over a low band width network. The lossy network transmission system can monitor the bandwidth across one or more networks in addition to signal quality more generally and determine, prior to transmission of the data, what payloads (i.e., what data to transmit over a network) and further, subsequent to receiving the data across the network, the lossy network transmission system can determine how to reconstruct the data should losses be incurred. Thus, “lossy” as used herein refers to any effects reducing signal quality. Lossy can refer both to losses due to network transmission, in addition to other losses in signal quality such as background noise, static, unexpected silences, and the like.

The network can include transmission of one or more payloads including an audio payload and/or a text payload. The audio payload represents the audio data for transmission over the network during a call and the text payload represents a transcription of the audio data. The transcription can broadly include pure text transcription (i.e., text in ASCII format) in addition to other data representations of the transcribed audio payload such as tokens, and other lower bandwidth data structures. In some examples, the input device transmitting the payloads transmits the audio payload and the text payload. In other examples, for instance, when the input device lacks a transcription service, the input device may transmit only the audio payload over the network, wherein it is received at a second device (e.g., receiving device 104) which can complete the transcription process. What payloads, between the audio payload and the text payload, are transmitted may also be configured based on the detected bandwidth of the network or signal quality. For instance, a bandwidth monitor may be configured to determine whether the bandwidth of the network is above or below a threshold value. Such threshold bandwidths may be tied to a minimum clarity for transmission of a given payload. If the network bandwidth is below the threshold, the lossy network transmission system can cause only the text payload to be transmitted over the network based on the severity of the bandwidth restriction. Similarly, signals may be monitored for factors beyond bandwidth affecting signal quality, such as background noise and the like, where subsequent augmentation and enrichment techniques may be used to improve signal quality despite such factors. In other examples, both the audio payload and the text payload may be transmitted over the network for regeneration once received at a second system, such as a server, or a recipient caller's device.

Once received by the server or the recipient device, the transmitted payload, including the audio and/or text, can be reconstructed based on the text data and an associated voice seed. A voice seed is a code identifier, linking the text data to a synthetic voice which may be output through a receiving device (also referred to as an output device) through text to voice conversion. The synthetic voice may be based on the input speaker's voiceprint, or natural speaking characteristics. In other examples, the synthetic voice may be unrelated to the input user's voice. The synthetic voice generated by the text payload and associated voice seed may then mirror the voiceprint of the input speaker. Thus, if the audio payload is not transmitted or if losses are incurred reducing the quality of the audio payload over transmission, the synthetic voice generated by the text payload and voice seed may then replace or supplement the lossy audio payload. In such a way, losses in signal quality over a call can mitigated despite high noise and low bandwidth over the network.

### Example Computing System for Lossy Network Transmission

FIG. 1 illustrates a system for transmitting various payloads across a network based on the network bandwidth and/or signal quality, according to certain embodiments. The computing system 100 is shown receiving data from an input device 102, converting the input into constituent data including payloads 108, 114, and transmitting output audio data 128 to a receiving device 104.

The input device 102 can include a mobile device such as a phone or laptop, or a computing device such as a personal computer. Generally, the input device 102 can be any electronic device capable of receiving and processing audio data including a voice input 106. Voice input 106, received from input device 102 is characterized by an audio payload 108 and voiceprint 110. The audio payload 108 refers to aspects of the voice input 106 providing semantic meaning, capable of being transcribed into text. The audio payload represents the data necessary for processing and transmission over one or more networks. The voiceprint 110 refers to non-linguistic characteristics of the audio input such as characteristics of the voice of the speaker providing the audio input. Voiceprint 110 can define the audio input pitch, tone, timbre, articulation, speaker cadence and rhythm, breath control, and any other characteristics reflective of the speaker providing the audio input. Subsequent processing may decouple the audio payload 108 and the voiceprint 110, for instance, by transcribing the audio payload 108.

The transcription service 112 can transcribe the voice input 106 and transform the audio payload 108 into the text payload 114, the text payload 114 representing the transcription of the audio payload 108 and voice input 106 more generally. Any variety of transcription services and algorithms may be used as the transcription service. For example, natural language processing techniques and neural structures such as convolutional neural networks and recurrent neural networks may be employed to process the voice input 106 and derive the text payload 114 as part of the transcription service 112. In some examples, the text payload 114 produced by the transcription service 112 can be a word for word transcription of the audio payload 108. However the text payload does not need to be stored in traditional text formatting (e.g., ASCII), and can be stored in data structures with lesser storage footprints, such as binary encodings, token encodings, and the like. Such reduced data formats can provide a further advantage in text payload transmission by further reducing the size of data to be transmitted over a network. According to some examples, the transcription service 112, relying on natural language processing techniques, can produce a text payload in an embedding level format, wherein the text payload 114 represents the audio payload 108 as vectors wherein the vectors can comprise segments representative of the text such vectors representative of words, phrases, sentences, or any other form of feature vector embedding as would be used per machine learning techniques. In such cases, the text payload 114 can represent lowered bandwidth data structures compared to a word by word transcription. The text payload, when in an embedding format, can then be recombined per a machine learning model trained via natural language processing techniques, according to certain examples.

In some embodiments, the computing system can include a filtration service 113 communicatively coupled to the transcription service 112. The filtration service 113, either as a component of the transcription service 112 or as a standalone component, can be keyed to the voiceprint 110 of the voice input 106 to assist in isolating the audio payload 108 and/or text payload 114. For instance, the voice input 106 when received by the input device 102 may contain noise signals such as significant ambient in the background of the audio input. Such unnecessary noise signals may both contribute to the signal bandwidth while also making it more difficult to hear the audio payload 108 when transmitted. In either case, the noise signal represents inefficiencies in the transmission of the audio payload 108. The filtration service 113 may isolate audio payload 108 to support transmission of only the audio payload 108. Additionally, the filtration service 113 communicates with the transcription service 112 to generate the text payload 114.

The filtration service 113 can also monitor signals transmitted over the network 120 to provide greater signal quality. For instance, the filtration service 113 can detect static and other noises affecting the audio payload, the noises originating during transmission of the audio payload over the network 120. In response, the filtration service 113 can work with the payload configuration module 116 to reconfigure the payload for transmission to minimize the negative effects of such noises.

The text payload 114 and the voice input 106 are shown as received by the payload configuration module 116. The payload configuration module 116, communicating with a bandwidth monitor 118, determines which payloads to transmit across one or more networks 120. For instance, the payload configuration module 116, can determine to send the voice input 106 and text payload 114 across the network (e.g., when the bandwidth is above a given threshold considered nominal), can transmit only the text payload 114 (e.g., when the network bandwidth is below a given threshold). In other examples, even upon detection of a lossy network with low bandwidth, the payload configuration module 116 may transmit a full stream of data including the voice input 106 and text payload 114, and then communicate with a regeneration module 126 across the network 120 to reconstruct the voice input 106 and text payload 114 with a chosen voice seed 124. Additional and alternative examples of methods by which the payload configuration module 116 can control transmission of payloads across the one or more networks 120 are discussed with respect to FIGS. 2-3.

The bandwidth monitor 118 can comprise one or more software applications across multiple devices configured to monitor each network 120. For instance, the bandwidth monitor 118 can be on one or more of the input device 102, receiving device 104, or any intermediary device (see e.g., FIG. 2). The bandwidth monitor can include any known techniques and software for monitoring the bandwidth of a given network. Examples of such software can include network traffic monitoring software using protocols such as Simple Network Management Protocol (“SNMP”), Windows Management Instrumentation (“WMI”), flow, protocol networks, internet control message protocols (“ICMP”) and the like. The bandwidth monitor can be programmed to evaluate the bandwidths of each of the one or more networks 120 against one or more thresholds. Bandwidth monitor, operating with filtration service 113 can further be configured to detect signal quality more generally (e.g., due to background noise and other static affecting signal quality) Each threshold can indicate a minimum quality of data preservation that would occur for transmission of given data. For instance, a first threshold can indicate whether to transmit a complete data set (e.g., the voice input 106 and the text payload 114), or a first reduction in data such as transmitting only the voice input 106. Additional threshold can indicate to the payload configuration module 116 to transmit only the text payload 114 across the network 120.

The bandwidth monitor 118, communicating with the payload configuration module 116, determines what payloads to transmit over the one or more networks 120. As will be discussed with respect to FIG. 2, the one or more networks 120 can include a sender to receiver network, a sender to central server network, a central server to receiver network, or any other network for data transmission. In some examples, payload configuration across each network of multiple networks may be controlled by the payload configuration module 116 in response to detected signal quality and bandwidths per the bandwidth monitor 118.

The network 120 is also shown receiving voice seeds 124 as stored in a voice seed database 122. Such voice seed database 122 is provided to illustrate one example means for retrieving voice seeds 124, though it is to be appreciated that voice seeds 124 can be stored across the computing system according to other examples, and that voice seed database may simply represent storage of voice seeds 124 somewhere in the computing system 100. In other examples, voice seeds 124 may be instantiated when called such that voice seeds 124 spend minimal to no time spent in storage. Voice seeds 124 can unique identifiers which identify how associated audio is to be modified to generate a synthetic voice. Each voice seed, when paired with associated audio, can modify the audio characteristics to generate a synthetic voice. The voice seed 124 for a given caller using an input device 102 can be generated based on the user's voiceprint 110. For instance, when the computing system 100 receives the voice input 106, the computing system can decompose the voice input 106 to identify the voiceprint 110. The voiceprint 110 may then be stored in the voice seed database 122 and retrieved for transmission across the network 120. A regeneration module 126 can apply the voice seed 124 to a text payload 114 to create a synthetic voice replicating the voiceprint 110 of the voice input 106 such that the output data 128 shares similar acoustic features to the voiceprint 110 of the voice input 106 even when only the text payload 114 is transmitted over the network 120. In other examples, a user providing the voice input 106 to the input device 102 can configure, through the input device 102, a paired voice seed 124 dissimilar to the user's voiceprint 110. For instance, a user can configure the regeneration module 126 to output a default voice through the output data 128 through a selected voice seed 124 within the voice seed database 122.

The network 120 is shown communicating with a regeneration module 126. The regeneration module 126 can receive payloads transmitted across the network 120 and be instructed, for instance, by data transmitted from the payload configuration module 116, to recombine the received data to generate the output data 128. Depending on the configuration of the payload transmitted across the network 120 and depending on the detected bandwidth of the network 120 and detected signal quality, the regeneration module 126 can perform different operations. For instance, the regeneration module 126 can receive only a text payload 114 and associated voice seed 124 transmitted over the network 120, or may receive the text payload 114, voice seed 124, and a partial audio payload 108 with loss due to network bandwidth constraints. In such examples, the regeneration module 126 can apply the received voice seed 124 to the text payload 114 to produce output data 128 including a synthetic voice replicating or replacing the original audio payload 108. The regeneration module 126 can supplement losses within the audio payload 108 due to losses across the low threshold network by overlaying the lossy audio payload as received from the network 120 with a synthetic voice mirroring the audio payload 108 generated by the text payload 114 and associated voice seed 124. In other examples, the regeneration module 126 may be a passive component. For example, when full transmission of the voice input 106 and the text payload 114 occurs across a network 120 with no detected loss, the regeneration module 126 may be inactive.

In some examples, the regeneration module 126 can include a large language model (“LLM”) trained to reconstruct received text payloads 114 transmitted over the network 120 which have deteriorated during the transmission, for instance due to high network traffic causing low bandwidth on the network. Thus, the text payload 114 that may be received at the regeneration module 126 can contain losses that would prevent the complete playback as output data 128 on the receiving device 104 absent further processing. According to certain embodiments, the regeneration module 126 can identify missing data from the text payload 114 such as incomplete phrases or words and apply an LLM contained within the regeneration module 113 to reconstruct the missing data by predicting the missing word, phrase, or the like based on the additional data contained within the transmitted text payload 114 which was not lost within transmission. Such predictive reconstruction of the lossy text payload 114 may generate an augmented text payload, where the augmented text payload represents the text payload 114 reconstructed by the LLM.

According to some examples, visual and auditory interfaces can be linked to the computing system 100 which are configured to indicate when the regeneration module 126 is regenerating audio payloads. As an example, visual or text overlays can report “this call is being supplemented with audio enrichment techniques” or the like. Other indicators such as noises (e.g., beeps) and visual flags can be used to indicate when a voice heard on a receiving device is being regenerated.

In the same or other examples, the text payload 114, prior to transmission may comprise lower profile textual data representative of the words and phrase within the text payload 114. For instance, the transcription service 112, working with the payload configuration module 116, may convert the text payload 114 into tokens. The tokens may then be transmitted across the network 120, where the LLM within the regeneration module 126 may process the tokenized text payload for output. Thus, the regeneration module 126 can further allow for lower profile data such as token transmission to occur over the network 120. The payload configuration module 116, according to certain embodiments, may then cause the text payload 114 to be reduced to tokens upon the network bandwidth reaching a specified threshold as detected by the bandwidth monitor 118.

Subsequent to transmission over the network 120, the data transmitted, whether further processed per the regeneration module 126, is represented by output data 128 for output to a receiving device 104. The output data 128 can comprise audio and/or text data. The audio data can include the unmodified voice input (e.g., per traditional transmission of voice calls over a high bandwidth network), modified voice input (e.g., supplemented or otherwise replaced by a text payload 114 paired with a voice seed 124 as generated by the regeneration module 126) or no audio data and only the text payload 114 (e.g., in low bandwidth networks, only a transcription may be generated). The output data 128 may then be output for listening and/or display on a receiving device 104. The receiving device 104, like the input device 102 can include a mobile device such as a phone or laptop, or a computing device such as a personal computer. The receiving device 104 need not have audio output capabilities, for instance when the output data 128 comprises text data but not audio data, and need not have visual interface, for instance when the output data 128 comprises audio data but not text data.

According to some examples, interfaces of the computing system 100 may regenerate and enrich data for output via the regeneration module 126 in response to user inputs. For instance, a recipient user may request clarification on a selected, unclear portion of an output textual or audio signal (e.g., due to background noise, loss, or the like). In response, the computing system 100 can modify the output signal via the transcription service 112 to generate textual payloads, which can then be displayed outputting a transcription of the unclear output data. Further, such transcribed text payloads can be augmented by the regeneration module 126 to provide an LLM predicted textual regeneration of the point of requested clarity. According to further examples, synthetic voices may be overlayed on the textual regeneration to provide an audio regeneration of the signal. Thus, users may interface with the computing system 100 to request greater clarity of output data 128 received across the network, and in response, the computing system can regenerate textual and/or audio approximations of the selected output data 128. Additionally, users may be able to select regenerated output such as text or audio transcriptions and provide their own inputs and revisions to correct instances where the regeneration module 126 initially output an incorrect regeneration of user provided input.

### Example Payload Transmissions Across Various Lossy Networks

FIG. 2 shows an example system illustrating various implementations of payload transmissions across multiple networks, according to certain embodiments. FIG. 2 illustrates that the described computing system including the payload configuration can be implemented on one or multiple computing systems across multiple networks. It is to be appreciated that the computing system 100 of FIG. 1 can be implemented across multiple devices such as input device 102, server 202, and receiving device 104, or can be implemented on a single device, such as server 202.

The payload configuration module 116 is shown as capable of being implemented on the input device 102, a server 202, and/or the receiving device 104. For instance, the payload configuration module 116 can be implemented on the input device 102 such that in response to detecting that the network 204 between the input device and server 202 is under a threshold bandwidth or signal quality, the payload configuration can configure the payload as described with respect to FIG. 1, at input device 102, prior to transmission such that minimal loss of data is incurred in the transmission across network 204. Additionally or alternatively, the payload configuration may be implemented and controlled at the server 202. For instance, the input device 102 may lack text to speech transcription capabilities. Therefore, payload configurations including text payloads 114 may not be possible for certain input devices 102. Instead, the server 202 with greater computing capabilities may instead generate the text payload 114 and adjust the payload for transmission across the network 206 between the server 202 and receiving device 104.

As shown in FIG. 2, the server 202 may be an optional component within the network. For instance, the input device 102 and receiving device 104 may communicate (e.g., transmit various payload configurations) directly and without requiring a server 202 serving as an additional medium of transmission. In such cases, the payload can be configured on the input device 102, and the regeneration module 126 can be stored on the receiving device for regeneration of the output audio data.

According to certain embodiments, the payload configuration module 116 is also shown communicating with the streaming service 130. The streaming service 130 includes further aspects of the computing system 100, wherein the streaming service 130 is capable of receiving audio payload 108 and text payload 114 as generated by the transcription service 112. The streaming service 130 provides additional functionality to stream aspects of the voice input 106 and provide users with access to the computing system via interfaces such as the input device 102 and receiving device 104 to participate in a multi-media stream and react to various aspects of the voice input 106 in real-time. Aspects of the streaming service 130 are further described with respect to FIGS. 6-8.

The regeneration module 126 may similarly be implemented either at the server 202 or the receiving device 104. Like the payload configuration module 116, regeneration may occur at the server 202 or receiving device 104 depending on the both the computing power of the respective device and/or the detected bandwidth of the network 206 linking the server 202 and the receiving device 104. For instance, the server 202 having greater access to computing resources such as machine learning capabilities, can implement the regeneration module 126 to reconstruct text based on machine learning and natural language processing techniques which may otherwise be unavailable at the receiving device. In the same or other instances, when the detected signal quality or bandwidth of the network 120 connecting the server 202 to the receiving device 104 is detected to be below given thresholds, the regeneration module 126 may reconstruct data to generate the output data 128 at the receiving device 104.

FIG. 3 shows an example system illustrating various payload configurations transmitted across lossy networks, according to certain embodiments. FIG. 3 shows a variety of users 302-306 communicating across network 120. The users 302-306 are representative of different scenarios in which the payload transmitted over the network may be configured based on the user's respective detected signal quality or bandwidth for communicating with the network 120. Such examples are non-limiting, and it is to be appreciated that according to other examples, other users may have different payloads configured according to different configurations.

First user 302 is shown as having a low bandwidth connection to the network 120. The bandwidth monitor may for instance detect that the first user's network bandwidth falls under several thresholds including a first threshold indicating whether to transmit audio and text, and a second threshold indicating whether to transmit only audio or only text. In response, the voice input 106 is converted to a text payload 114. The text payload 114 may then be streamed over the network, in addition to a voice seed 124 associated with the first user 302. The voice seed 124 may be transmitted over the network 120 or may be otherwise retrieved from a voice seed database 122 stored across the network 120. Thus, only the text payload 114 may be transmitted across the network in response to the first user 302 being detected has having a slow network under multiple threshold bandwidths. The regeneration module may optionally reconstruct the user's voice input 106 by combining the text payload 114 with the voice seed 124 to produce a synthetic voice with similar characteristics to the first user's voiceprint 110.

Second user 304 is shown having a low bandwidth connection to the network 120. The second user's connection to the network may be determined as spotty, or otherwise below a first threshold but above a second threshold related to bandwidth strength. The second user's input device may be configured to transmit both the text payload 114 and the voice input 106 across the network to the server 202. In response, the server, through the regeneration module, can reconstruct or supplement any losses in the voice input 106 by generating a synthetic voice based on the text payload 114 and the associated voice seed 124.

Third user 306 is shown having high bandwidth and a strong connection to the network 120. The third user's connection may thus be identified as exceeding bandwidth thresholds as identified by the bandwidth monitor. In response to determining the user bandwidth exceeds all thresholds, the user's text payload 114 and voice input 106 may be transmitted over the network 120 to the server 202.

FIG. 4 shows an example process 400 for configuring payloads for transmission across a network according to certain embodiments. For illustrative purposes, the process 400 is described with reference to implementations described above with respect to one or more examples described herein. Other implementations, however, are possible. In some aspects, the operations in FIG. 4 may be implemented in program code that is executed by one or more computing devices such as the computing system 100 of FIG. 1. In some aspects of the present disclosure, one or more operations shown in FIG. 4 may be omitted or performed in a different order. Similarly, additional operations not shown in FIG. 4 may be performed.

At block 402 the process 400 involves receiving a voice seed 124. The voice seed 124, also referred to as voice seed configuration, as described with respect to FIG. 1 contains information identifying how associated audio is to be configured or modified to generate a synthetic voice. Voice seeds identify synthetic voices corresponding to the user providing the input voice into the call, for instance when the user would like to more accurately recreate their voice during lossy periods. Alternatively the user can specify different voice seeds, such as default voice seeds corresponding to a default synthetic voice as to be associated with a regeneration process. Receiving the voice seed 124 can occur in response to a user pre-configuring the voice seed in default settings. For instance, a user may select a specific voice seed for retrieval to supplement or replace their voice input 106 after transmission.

It should be noted that the voice seed configuration may be received at the input device 102, receiving device 104, server 202, or another device within the path of transmission of the various payload configurations. For instance, a voice seed database may be local to one or more of the above mentioned devices. Thus, according to certain examples, the voice seed can be transmitted across the network, and in other examples, need not be transmitted, and instead only retrieved by a receiving device 104.

At block 404, the process 400 involves receiving a voice input 106 comprising an audio payload and a voiceprint. As describe above, the audio payload and voiceprint, when received, are intertwined, where the audio payload represents the semantics and content for transmission, while the voiceprint reflects the aesthetic characteristics accompanying the audio payload. As discussed further below, certain examples are directed to recreating the voiceprint on a receiving device despite potential losses in transmission across one or more networks.

At block 406, the process 400 involves detecting a bandwidth of a network or a signal quality associated with the voice input is under a first threshold. The signal quality associated with the voice input can in some instances be directly affected by network bandwidth, such as when low bandwidth networks cause deterioration in signal quality. Additionally, signal quality can be affected by other factors such as static, noisy data, missing words, unexpected silence, and the like. The bandwidth monitor 118 may thus be configured to monitor not only bandwidth across one or more networks 120 but, in conjunction with a filtration service 113, be configured to monitor the signal quality associated with the voice input such as due to effects of background, noise, static data, and other noise affecting signal quality.

The bandwidths and signal quality can be compared against one or more thresholds. The threshold may be defined by an instantaneous bandwidth value, or average bandwidth over a specified amount of time. For instance, the first threshold may be defined as averaging below a threshold Mbps rate for over a specified time period. Signal quality thresholds can relate to threshold audibility of background noise and other static, in addition to averages in dead air in which no audio signals are picked up. Generally, the first threshold may be defined as a minimum value for preserving clarity of the input audio/text payload signal. In one example, the first threshold relates to whether to transmit both the audio and text payload 114 (if over the first threshold) and transmitting only the text payload 114 (if under the first threshold). Additional thresholds may be added to distinguish different payload configurations transmitted over the network 120 or reconstructed after transmission across the network. For example, FIG. 5 discusses additional thresholds contemplated according to certain embodiments.

At block 408 the process involves converting the audio payload into a text payload 114 comprising textual speech data that represents the audio payload. A transcription service 112 may be employed to convert the audio payload 108 of the voice input 106 into the text payload 114. The text payload 114 represents the text transcription of the audio payload 108. Block 408 may be performed before or subsequent to the bandwidth monitor 118 detecting the network bandwidth and/or signal quality being under a threshold value. Transcription per block 408 may also occur after transmission across the network 120 according to certain examples.

At block 410, the process involves transmitting the text payload and/or the audio payload over the network. In response to the bandwidth or signal quality being detected under the first threshold per block 406, the process 400 can transmit the audio payload and/or text payload over the network 120 depending on a specified configuration. Various examples of payload configuration may be employed. For instance, block 408 can involve transmitting the audio payload 108 and text payload 114 across the network and cause a regeneration module 126 across the network to reconstruct portions of the audio payload 108 based in part on the text payload 114 and associated voice seed 124. Block 408 can involve transmitting the text payload 114 only and not the audio payload, and again rely on the regeneration module across the network to wholly reconstruct the audio payload 108 based on the text payload 114 and associated voice seed 124 producing the synthetic voice representative of the audio payload 108.

At block 412, the process 400 involves generating output audio data based in part on the text payload applied to the voice seed 124. According to certain examples, the audio payload 108 may be transmitted across the network 120 despite the bandwidth monitor 118 detecting a lossy period indicating that clarity of the audio payload 108 would not be preserved. Thus, the audio payload received at a second device across the network 120 may be lossy with aspects of the signal deteriorated. However, with the text payload 114 and the voice seed 124 additionally received by the secondary device, the secondary device can employ a regeneration module 126 to reconstruct portions of the audio payload 108 to restore a partially synthetic audio payload as part of output data 128. Particularly when the voice seed 124 corresponds to a synthetic voice keyed to the input user's voiceprint 110, the output data 128 may be perceived as identical to the voice input 106. According to other examples, as discussed in FIG. 5, only the text payload 114 may be transmitted over the network 120 and instead wholly reconstruct the audio payload 108.

In some examples, the generated output audio data can be generated based on a voice seed configured to recreate characteristics of the voiceprint. In such a way, the output audio data can be reconstructed to recreate audio characteristics of a speaker (e.g., tone, pitch, frequency, cadence, and the like) providing the audio input data. For instance, the voice seed can be assigned to a synthetic voice based on the voiceprint of a given speaker. Audio analysis techniques including analog to digital converters coupled to frequency analysis tools can be used to identify characteristics of a voiceprint and associate those voiceprint characteristics with a given voice seed. In such cases, the output will be a synthetic voice that features aspects of the user's natural voiceprint, including producing an acoustically identical audio output reflective of the audio input. FIG. 5 shows a further example processes 500 510 for configuring payloads for transmission across a network according to certain embodiments. For illustrative purposes, the processes 500 510 are described with reference to implementations described above with respect to one or more examples described herein. Other implementations, however, are possible. In some aspects, the operations in FIG. 5 may be implemented in program code that is executed by one or more computing devices such as the computing system 100 of FIG. 1. In some aspects of the present disclosure, one or more operations shown in FIG. 5 may be omitted or performed in a different order. Similarly, additional operations not shown in FIG. 5 may be performed.

Process 500 illustrates further examples of payload configuration based on additional thresholds. At block 502 the process 500 involves detecting the bandwidth or signal quality of the network is under a second threshold lower than the first threshold. Falling under the second threshold is thus indicative of lower clarity preservation should both the audio payload 108 and text payload 114 be delivered over the network 120. Thus, the payload configuration module 116 may determine to transmit, per block 504, lower bandwidth data compared to when the second threshold is satisfied but the first is not. Such lower bandwidth data can entail transmitting the text payload 114 but not the audio payload (e.g., when the falling under the first threshold still transmits both). Further, falling under the second threshold can involve transmitting the text payload 114 in a reduced data format such as in vector embeddings to regenerated via natural language processing and machine learning techniques. Such techniques are discussed further with respect to process 510.

According to certain examples, the text payload 114 can comprise data formats for storing traditional string-based text such as traditional ASCII characters as the base data structure for transmission. Alternatively, the text payload 114 may comprise lower bandwidth encoding data structures. According to certain examples, natural language processing techniques may be used to create vector representations of the text payload 114 to provide a further reduction in bandwidth of the text payload 114 for transmission across the network 120. Natural language processing tools such as LLMs trained to generate tokens and word vector embeddings preserving the semantic meaning of the text payload 114 while preserving semantic meaning may be employed. Examples of LLMs used for natural language processing for use in generating the word vector embeddings may include those such as Generative Pre-trained Transformers (“GPT”), Bidirectional Encoder Representations from Transformers (“BERT”), and the like. Process 510 describes additional implementations where LLMs may be provided as part of the lossy network transmission process. Particularly, Process 510 describes instances, wherein the bandwidth monitor detects the network bandwidth or signal quality as under a threshold yet transmits the audio payload and/or text payload 114 despite expecting losses to be incurred. Instead, process 510 relies on regeneration of the audio payload and text payload 114 through natural language processing techniques to account for the losses incurred in transmission.

At block 512, the process 510 generates output audio data based in part on the text payload 114 applied to the voice seed 124. Block 512 is similar to block 412 of process 400, and is shown to indicate, according to certain examples, additional operations that can be performed per process 400 at block 412.

At block 514, the process 510 involves applying the text payload 114 to a trained large language model (“LLM”) to generate an augmented text payload. Generally, block 512 may be performed at a server level, where the server 202 receives the audio payload 108 and/or the text payload 114 and is has the compute power to access a trained LLM. The server 202 may then generate an augmented text payload by inputting the text payload 114 into the trained LLM. The trained LLM may thus use predictive analytics to recreate the voice input 106 despite losses in transmission.

Because the LLM relies on statistical predictions to generate the augmented text payload, which may not perfectly correspond to the voice input 106 from prior to transmission, use of the augmented text payload may be configured by the user providing the voice input 106. For instance, the user may specify through a user interface whether to completely reject the use of augmented text payloads or may specify a threshold accuracy in the LLM's predictions in generating the augmented text payload. For instance, the user may specify that the augmented text payload can only inject and supplement the audio output if it has a threshold confidence in a predicted word as exceeding 98% accuracy.

At block 516 the process 500 generating output audio data based in part on the augmented text payload applied to the voice seed. Block 516 thus shows an alternative example in which the lossy network system can reconstruct audio payloads as output data 128 for output on a receiving device 104. As with block 412 of process 400, the output audio data may be keyed to the input audio data's voiceprint based on the associated voice seed as applied to the augmented text payload. Thus, the output audio can include a reconstructions of the input audio data both with respect to acoustic quality (through the voice seed 124) and with respect to syntactical structure (through the augmented text payload), despite losses in transmission.

Advantages of Systems and Methods for Lossy Network Transmission

The described systems and methods for lossy network transmission provide several technical advantages in the field of telecommunications and network management. The described payload configuration system tied to the bandwidth monitor is able to respond to changes in network bandwidth or signal quality and transmit audio and/or textual data accordingly. Such configurations allow for the network bandwidth to be preserved while also preserving the quality of data transmitted. Moreover, the voice seeds, applied to textual payloads, can reconstruct output data mirroring the sound of the input audio data. Thus, the end-user experience of receiving a call is not diminished despite significant improvements in data reduction and bandwidth preservation.

The manipulation of input audio data into textual payloads and subsequent auditory reconstruction with voice seeds provides further benefits when applied through the described regeneration module when including a trained LLM. The trained LLM can reconstruct text payloads to generate augmented text payloads to counter losses incurred during transmission. Further coupled to the voice seed to generate synthetic voice output, the described system can generate audio output indistinguishable from the audio input despite any losses incurred during transmission.

For example, according to certain examples, the generated output audio data is configured (e.g., through the voice seed) to include a synthetic voice sharing characteristics of the speaker providing the input audio (e.g., sharing characteristics of the speaker's voiceprint). Such techniques provide an improvement in the art of audio communications and signal transmission by improving the aesthetic quality of conversations, particularly during lossy periods. When a synthetic voice is generated, keyed to a user's voiceprint, the quality of the audio output can better reflect the quality of the audio input, even when augmented payloads and other data reconstructions are applied to counter the losses incurred during network transmission.

Example Computing System for Interactive Multi-Media Streams

In some examples, the described computing systems can provide an interface for multi-media interaction through a multi-media streaming interface. FIG. 6 shows a system for interacting with a multi-media stream with multi-media input such as audio input (e.g., including voice input 106) and visual input including images according to certain embodiments. The streaming service computing system 600, can be a component of the computing system 100 of FIG. 1 (e.g., described as the streaming service 130). According to other embodiments, the streaming service computing system 600 may be a separate computing system from computing system 100.

The streaming service computing system 600, working with or independently of the computing system 100 provides for additional techniques for interacting with voice to text conversions within a multi-media stream, in addition to image to text conversions provided within the stream. Particularly where the multi-media stream includes several different forms of media including video input, audio input, text input (e.g., through an instant messenger or general chat) and image input (similarly generally displayed within the instant messenger or general chat), providing systems and methods for indexing the multi-media inputs and providing techniques for responding the various multi-media inputs can provide improvements to livestreaming services integrating voice to text transcription.

As a practical example, a first user participating in the stream may provide audio input subsequently transcribed and displayed according to a transcript index. A second user wishing to react to the first user's voice input can navigate the transcript index, highlight the transcribed portion corresponding to what was said, and enter a new form of input in response, where the new input includes a pointer linking to the transcribed audio input from the first user. As described further, different examples are enabled according to the current streaming service computing system 600 allowing for users to interact with various multi-media inputs into the multi-media stream via several respective indexes.

The streaming service computing system 600 is shown receiving a multi-media stream 602 from a network 601 via a network interface 603. The streaming service computing system 600 also can receive inputs interacting with the multi-media stream from an input device 605. Such inputs, referred to as the multi-media inputs 610 include audio inputs 612, image inputs 614, and response inputs 616. The described computing system 100 can allow a user, interfacing via the input device 102 to view a multi-media stream 602 and provide various multi-media inputs 610. Such multi-media inputs may be displayed on the multi-media stream 602 and additionally logged within one or more indices 622 in an index repository 620. An indexer 618, providing the logic to log the multi-media input 610 with respective index repositories 620 can enable various means for a user to interact with the multi-media stream 602 in ways not present in traditional computing means, such as by reacting to live voice inputs by other users similarly participating in the multi-media stream 602.

The multi-media stream may be a livestream, and may also be a pre-recorded stream (e.g., subsequent a livestream ending where the stream was otherwise recorded). In examples where the multi-media stream interface provides edits to a previously recorded stream, users may for instance interact via tagging previous points within the stream timeline or redact elements within the stream. When such modifications to the post-live stream, other users associated with that multi-media stream (e.g., participants within the original livestream) can be notified of the interaction and be invited to view and react to the newly added interactions. In such a way, the ability to interact with the original stream may be extended after a given livestream terminates the initial livestream call.

The streaming service computing system 600 of FIG. 6 begins by receiving a multi-media stream 602 from a network 601 via a network interface 603. The network 151 may be the same or a different network described with respect to FIG. 1, wherein the network, in addition to streaming audio payloads and text payloads, may also transmit video and image payloads. Given that such image data has a larger bandwidth compared to audio and text based data, in a preferred example, the computing system 100 can integrate the aspects discussed with respect to FIG. 1 with the streaming service computing system 600 discussed with respect to FIG. 6.

The network interface 603 is shown receiving the multi-media stream 602 via the network. The network interface 603 can include a network interface card (“NIC”) and enable reception of the multi-media stream over wi-fi, ethernet, and other means of data transmission. Additional description of network interface 603 features are described with respect to FIG. 9

The multi-media stream 602 can include audio content 604, visual content 606, and chat content 608 among other forms of content. Audio content can include voice input from various users with access to the multi-media stream, music, audio associated with other media (e.g., audio corresponding to visual content such as a recorded video), and the like. Visual content can include prerecorded or live videos (e.g., livestream camera input), images, live document shares (e.g., a shared WORD or PDF document) and the like. In some examples, the multi-media stream 602 can include a livestream for teleconferencing, providing users different abilities to interact with the video stream such as through various multi-media input 610.

The multi-media input 610 includes various forms of input for interacting with the multi-media stream including audio input 612. The audio input for instance can be a user's recorded voice captured by an input device 102. The user may for instance press a selection menu including means for responding within the multi-media stream 602 and select to respond by providing audio input 612. The audio input can be their own voice as recorded through an input device 102, or a selected audio input such as quoting another user who has previously provided audio input 612 into the multi-media stream 602.

The multi-media input 610 includes image input 614. Image input can include any format of image such . jpeg, . png, gif, and the like. In some examples, the image input 614 can comprise video input as a collection of frames of images. The image input 614 may be uploaded by the user interacting with the multi-media stream 602 or may be selected from an assortment of images contained within the multi-media stream interface.

The multi-media input includes response input 616. Response input allows a user to interact with previous multi-media inputs and content within the multi-media stream. The response input 616 indicates a selection of one or more of the multi-media inputs 610 or content components of the multi-media stream 602 for the user to provide a response to. The response input 616 can comprise any type of multi-media input such as a user's voice (including a voice to text transcription of the user's voice), text-input, image input, video input, and the like. The response input 616 can also include metadata for pointing and linking the original input the response input 616 is reacting to. As an example, a user may navigate a given index of the multiple indices 622, select content to react to (e.g., for reacting to a previous voice input, the user would select text in the transcription index) and then provide the response input 616. In navigating a given index of the multiple indices 622, users can interact with multiple timelines and points within each index. For example text input from a first index can be selected while image inputs from a second index, associated with a different point in time can be selected. In such examples, different points in time within a video may all be concurrently referenced through a given response input 616.

The response input in some examples will then be displayed in a corresponding index (e.g., the audio index) and may point to the original input made in response to or may be linkable such that clicking the response input 616 automatically navigates a user to the original input.

Each of the multi-media inputs 610 and multi-media stream contents 604-608 may be cataloged in an index repository 620 containing multiple indices 622. The indexer 618, in response to any multi-media input 610 received by the one or more input devices 102, can log the multi-media input in corresponding indices 622. The indices can include a transcript index, an image index, a video index, a chat index, and a tag index among additional indices. The indices 622 can refer to data location storage coupled to navigable, displayable portions (see e.g., FIG. 7) of the multi-media stream which provide a history of a specified content. For instance, a chat index can refer to the chat log as recorded and displayed within the multi-media stream, while a video index can refer to a navigable frame-by-frame navigational pane for traversing the multi-media stream based on a series of frames. A tag index can refer to a repository for linking and pointing between inputs into the stream. For example, a response input can be stored in the tag index, where the tag input records the response input, and the previous input the response input was provided in response to. Thus, the tag index may allow for tracking and navigating the multi-media stream based on interactions between inputs.

It is to be appreciated that while several distinct indices 622 are described including the transcript index, image index, video index, chat index, and a tag index, in implementation, various configurations of such indexes may be present. For instance, each index can be stored within one central index, and in the same or other examples, one or more of the described indexes may not be present. Thus, while such indexes are described according to the example of FIG. 6, other variations of the indexes are possible.

The streaming service computing system 600 of FIG. 6 is also shown including a text converter program 624. The text converter program 624 can include an audio transcription which can comprise the same transcription service 112 of FIG. 1, or a separate transcription service. The text converter program 624 additionally includes an image to text transcription service 626. The image to text transcription service 628 can employ various algorithms and techniques to generate a text-based representation of the image input 614 including optical character recognition (“OCR”) text elements within the image input 614. Techniques such as image tagging including zero-shot image tagging relying on convolutional neural networks (“CNN”) may be used to extract other elements including text elements describing visual aspects of the image input 614. Thus, the text converter program 624 can receive non-textual based multi-media inputs such as audio inputs 612 and image inputs 614 and convert each type of input into textual based output. Such text based outputs may be displayed back within the multi-media stream in a corresponding index and may provide users means to query and interact with the indices within the index repository during the live stream.

The streaming service computing system 600 of FIG. 6 is also shown capable of receiving selections 630 from an input device including index display selections 632, quote selections 634, and response selections 636. Such selections 630 illustrate various means by which users, through input devices, may interact with the multi-media stream 602.

Index display selections 632 include selections to display one or more specified indices 622 within the index repository 620. As a result of the selection, the corresponding index may be displayed on the multi-media stream 602. For instance, a user may select to display a combination of the transcript index, image index, and time index, while deselecting the display of the video index and tag index. Various combinations and entries of display selections thus allow a user to determine which of the several available indices to display at any given time within the multi-media stream.

Quote selection inputs 634 include selections made to a previous entry in the one or more indices 622. For instance, when the transcript index is displayed, a user may select a previous audio input 612, presented as transcribed text in the text index, for quoting. Thus, the quote selection input identifies a quote element, where the quote element represents a subset of the text element corresponding to a subset of the audio or image input. As an example, a user's transcribed audio, displayed in a transcript index, may be selected via the quote selection input 634. The user may select the full transcription of what was said, or a subset of what was said as reflected in the transcript. The selected portion, the quote element, can then be logged in a corresponding index and displayed, for instance in the chat index. The quote element as displayed may directly point to, or otherwise link to the corresponding transcribed audio displayed in the transcript index.

Response selections 636 represent means by which a user may determine how to respond to content within the multi-media stream and/or index repository 620. For instance, upon selection of a prior comment within the chat index, the user may select to respond via providing their own text input, audio input 612, image input 614, or any other means of responding to the selected content.

In some embodiments, the streaming service computing system 600 includes a stream log 638 providing storage for some or all of the multi-media streams received and recorded over the network 601. The stream log 638 can thus retain copies of each multi-media session. For instance, a year's worth of weekly calls can be stored in the stream log 638 or other databases. In such storage mechanisms, the indices as previously described can allow for various searches to be performed across the stream log 638. Users can select one or more of the indices for searching, in addition to ranges of previous streams within the stream log 638 (e.g., filtered according to date ranges and/or participants within the stream). The stream log 638 further allows for cross-referencing between streams. Response inputs 616 may thus be related to selection of indices within a current multi-media stream, while also allowing users to respond to a given multi-media element with a selection of multi-media elements from previous multi-media streams. In such examples, users can interact by quoting text or audio elements from within a prior stream for incorporation into the current multi-media stream.

### Example Interface for Interactive Multi-Media Streams

FIG. 7 shows an example interface for interacting with multi-media streams, according to certain embodiments. The interface 700 is shown including components described with respect to the streaming service computing system 600 of FIG. 6. While an example interface is shown, it is to be appreciated the described interface 700 may comprise different orientations and organizations of the described features in addition to other features not shown.

The interface 700 is shown including a display including content such as visual content 702 and chat content 704. Display indexes are shown including visual display index 706, allowing for navigation of various frames of the visual content 702, and a time display index 708 similarly allowing for navigation of the multi-media stream. The indexes are shown as displayed indexes according to the display interface 700 of FIG. 7. Thus, a user may be able to interact with the various indices such as those described with respect to FIG. 6 through viewing and selecting the displayed indexes. For instance, a user may configure the interface through an index selection interface 712 and a content selection interface 714 to show different arrangements of the indices and content including more or fewer indices and content. The selected indices may then provide the user for different means of navigating the multi-media stream, wherein each index provides a separately traversable log of content provided in the multi-media stream. Additionally, a response display interface 710 (allowing users to traverse an index storing previous interactions within the interface) and a transcription display index 716 (allowing users to traverse a transcription index) are shown, allowing a user to interact with the content as displayed within the multi-media stream.

It should be appreciated that while FIG. 7 shows an example interface 700 according to one examples, including various display indexes 708-710, and 716, in addition to various forms of content 702-704, other configurations of content for display and display indexes for navigation may be present according to other examples. Additionally, while different display indexes are described, various different indexes may be combined according to other examples. For instance, response display index 710 and transcription display index 716 may be combined as one index display, according to some examples.

In an example use case of the interface 700, the multi-media stream may include a first user talking (providing audio content 604 into the multi-media stream) and presenting (providing visual content 606, 702). A second user may want to respond to what the first user's audio content, or another user's content provided within the multi-media stream. For instance, the second user may want to comment on or ask a question in response to what has been shown or said. The second user may then select the response display interface 710 or the transcription interface 716 to initiate a response. The second user can then choose to respond directly to the audio content (via a selection of the voice to text transcript displayed within the transcription index), the image that has been shown in the image index, or any other specific form of content as provided within the multi-media stream. The second user can choose to respond to multiple components within the same selection.

In a next step of the above example, after having selected which content to respond to, the second user may then select which format the second user would like to respond in. For instance, the second user may choose to respond via their own audio input 612, image input 614, chat input, or other form of interacting with the selected content for response.

In some examples, the audio to text transcription service 626 can allow users such as the second user to interact with the multi-media stream interface without having to work directly through the response display interface 710. The audio to text transcription service 626 can instead detect voice commands input by the user and determine which index to respond to and the form of response. A user interacting with the system may thus select indices and means of responding by providing voice input and commands. As an example, a second user may provide audio input stating “I am responding to Jane's previous comment and would like to repeat her point in the chat.” In response, the audio to text transcription service 626 detects the voice input as a command, and adds to the chat content 704, the second user's input as a text response and tags the preceding comment left by the user Jane. In such examples, users can interact with the various content in the indices 622 without having to interface with a corresponding displayed index (e.g., 706-710, and 716). Other examples are contemplated where a user can enter a voice command identifying one form of content to respond to, and another form of response, for instance, through audio input or image input, or other forms of input as previously described.

FIG. 8 shows an example process 800 interacting with a multi-media stream according to certain embodiments. For illustrative purposes, the process 800 is described with reference to implementations described above with respect to one or more examples described herein. Other implementations, however, are possible. In some aspects, the operations in FIG. 8 may be implemented in program code that is executed by one or more computing devices such as the computing system 100 of FIGS. 1 and 6. In some aspects of the present disclosure, one or more operations shown in FIG. 8 may be omitted or performed in a different order. Similarly, additional operations not shown in FIG. 8 may be performed.

Similar to the indexes described with respect to FIG. 6, the indexes described with respect to process 800 can generally refer to memory storage locations for logging various interactions with a multi-media stream, such as a time index which comprises a log of records tracking each interaction within the multi-media stream, indexed by time. The indexes as described need not be displayed according to certain examples. However, according to other examples, the indexes as described may be visually represented (e.g., as in FIG. 7) for display within the multi-media stream, allowing for various users to view and interact with the various indexes. While separate indices are described, it is to be appreciated that indexes can be combined, either in storage or via display, such that multiple indexes are stored or displayed within the same location within the multi-media stream.

At block 802, the process 800 involves receiving a multi-media stream comprising audio content, visual content, and chat content. Audio content can include voice input from various users with access to the multi-media stream, music, audio associated with other media (e.g., audio corresponding to visual content such as a recorded video), and the like. Visual content can include prerecorded or live videos (e.g., livestream camera input), images, live document shares and like. It should be noted that when displayed on various receiving devices, the visual content on each device need not be identical. For instance, for visual content including live document shares, the visual content displayed on a first device to a first user can include a first view of the live document while the visual content displayed on a second device to a second user can include a different view of the same live document, or other live document. Thus, different users, each with a respective local view of a given document within the multi-media stream, may have different, respective views of the document. Additionally, the multi-media stream 602 may be a live stream or teleconference, wherein one or more users are providing the audio content 604 and visual content 606, while the same or other sets of users are providing chat content 608.

At block 804, the process 800 involves receiving a first multi-media input comprising an audio input or an image input. The first multi-media input may be input via a user interfacing via the input device 102. The user may select one or more of the content streams including the audio content 604, visual content 606 or chat content 608 to respond to. The user can also navigate one or more of the indices 622 to identify the specific content to respond to within the stream. The user may then make selection of what input to provide, including an audio input 612, image input 614, response input 616. Once selected, the user may then provide the selected input through the input device 102.

At block 806, the process 800 involves indexing the first multi-media input in a time index and a selected index of one or more content indices. A time index can record all multi-media inputs 610 received within the multi-media stream 602 and provide a logging of the time the multi-media inputs 610 are received, displayed, or otherwise interacted with within the multi-media stream. The time-index may thus provide a means for cross-referencing and linking other indices within the multi-media stream, according to certain examples. The time index can also record chat content 608. The time index thus represents one index by which a user can navigate inputs and contents as entered into the multi-media stream. Additionally, the first multi-media input may also be tracked in a selected index. The selected index can correspond to the type of multi-media input receive per block 804. For instance, image input 614 may be logged within the image index in addition to the time index. Audio inputs 612 may also be logged the audio index for retrieval and for interaction from subsequent users.

At block 808, the process 800 involves converting the multi-media input into a text element that is representative of the first multi-media input. The image input 614 may also be converted to text though the image to text transcription service 628, and the text conversion logged in the chat index. The audio input 612 may also be converted to text through the audio to text transcription service 626, wherein the text transcription is stored in additional indices. In examples where LLMs are applied to generate text transcription predictions, or when used for synthetic regeneration of audio output, auditory or visual indicators can be output indicating that machine services were used to regenerate the signal and thus, that any output signals do not exactly correlate to input. The indicators may be output to the user providing the input (i.e., so the input user can consent or otherwise be informed that their input is being supplemented according to machine techniques), in addition to being provided to recipient users so that the recipient users may similarly be informed of potential inaccuracies resulting from use of machine techniques to supplement input data.

At block 810, the process 800 involves displaying the text element within the multi-media stream 602. The text element, representative of the multi-media input 610, whether it was originally an audio input 612 or image input 614, may be provided within one or more indices 622 and additionally displayed on the multi-media stream 602. The text element may be displayed in response to a request from a user to display the respective index, or upon the system receiving a query from a user to retrieve the specified text element. In such a way, users can interact with non-textual inputs such as the original audio input 612 or image input 614 through interaction with the corresponding text element.

At block 812, the process 800 involves receiving a response input responsive to the text element. Upon selection of the text element, a user may be displayed one or more options to interact with the text element. For instance, the user can input another multi-media input 610 in response to the selected text element. As an example, a second user may select a text element representative of a first user's voice input to the multi-media stream 602, where the first user's audio input includes a request for a specific chart. The second user may then select the first user's audio to text converted question and select an option to respond with a corresponding image containing the requested chart. When the chart as an image input is entered into the multi-media stream 602, the process may then repeat where the chart is displayed, indexed in the time index and the image index, and converted to text through the image to text transcription service 628 allowing additional users to interact with the chart image as an additional multimedia input. When added to the stream, the chart may be merged into the stream according to some examples, and in other examples, may be considered a new branch of the stream in such interfaces where multiple versions of the multi-media stream are enabled.

At block 814, the process 800 involves indexing the response input in the time index and the selected index. The time index can represent a log of all interactions and media inputs provided within the livestream, and when paired with other indexes, provide a navigable, time based location of response input. The selected index can be determined based on the type of response input provided. For instance, if the response input is provided via a user's voice, the selected index(ices) can include the transcription index. Thus, the response input can be logged based on time of response and the type of response, providing multiple means for navigating the multi-media stream and interacting with various media inputs within the stream.

### Advantages of the Interactive Multi-Media Stream Computing System

The described systems and methods for interactive media streaming provide an improved user interface and user experience when partaking in multi-stream services. Specific implementations of a transcript service coupled to an indexer are described where the transcript service can process audio data and/or visual data and generate an associated transcript. The associated transcript can be tagged in multiple indexes navigable by a user such that the user can select one or more of the indexes to respond to the audio and/or visual data. Particularly the content of each index may be tagged or linked to content within other indexes, allowing for the fluid interaction between various streams of data including voice, text, images, videos and the like. The previous lack of linkable, traceable, and searchable transcriptions in multi-media streams provided a technical limitation in previous multi-media streams and computing systems more generally.

### Example Computing Environment For Implementing the Described Transcription Systems

Any suitable computing system or group of computing systems can be used for

performing the operations described herein. For example, FIG. 9 shows a block diagram for an example computing environment 900 capable of executing the described systems and methods, according to certain embodiments. The example computing environment is shown as a capable of running the described computing system 100 of FIG. 1 in addition to the streaming computing system 600 of FIG. 6. In some examples, the computing system 100 and streaming computing system 600 may be implemented on the same example computing environment 900 as shown in FIG. 9. In other examples, more or fewer components may be implemented, for instance, when the computing system 100 and streaming computing system 600 are operating on different computing environments.

The depicted example of a multi-media stream computing system 902 includes one or more processors 906 communicatively coupled to one or more memory devices 904. The processor 906 executes computer-executable program code or accesses information stored in the memory device 904. Examples of processor 906 include a microprocessor, an application-specific integrated circuit (“ASIC”), a field-programmable gate array (“FPGA”), or other suitable processing device. The processor 906 can include any number of processing devices, including one.

The memory device 904 includes any suitable non-transitory computer readable medium for storing one or more of the described computing system components including transcription service 922, payload configuration module 924, bandwidth monitor, indexer 928 and other dynamic instructions 930 or received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 902 may also include a number of external or internal devices such as input or output devices. For example, the multi-media stream computing system 902 is shown with an input/output (“I/O”) interface 908 that can receive input from input devices or provide output to output devices. A bus 908 can also be included in the multi-media stream computing system 902. The bus 908 can communicatively couple one or more components of the multi-media stream computing system 902.

The computing system 902 executes program code that configures the processor 906 to perform one or more of the operations described above with respect to FIGS. 1-8. The program code includes operations related to, for example, receiving and ingesting data files, generating metadata associated with the data files, and determining access to the data files, or other suitable applications or memory structures that perform one or more operations described herein. The program code may be resident in the memory device 904 or any suitable non-transitory computer-readable medium and may be executed by the processor 906 or any other suitable processor. In some embodiments, the program code described above, including transcription service 922, payload configuration module 924, bandwidth monitor, indexer 928 and other dynamic instructions 930 or received or determined values or data objects are stored in the memory device 904, as depicted in FIG. 9. In additional or alternative embodiments, one or more of the including transcription service 922, payload configuration module 924, bandwidth monitor, indexer 928 and other dynamic instructions 930 or received or determined values or data objects described above are stored in one or more memory devices accessible via a data network, such as a memory device accessible via a cloud service.

The multi-media stream computing system 902 depicted in FIG. 9 also includes at least one network interface 912. The network interface 912 includes any device or group of devices suitable for establishing a wired or wireless data connection to one or more data networks 914 such as viewing applications 920 including user interfaces. Non-limiting examples of the network interface 912 include an Ethernet network adapter, a modem, and/or the like. A remote communication service 918 is connected to the multi-media stream computing system 902 via network 912 and can perform some of the operations described herein including generating templates or receiving messaging data and applying the messaging data to a specified template. The computing system 902 is able to communicate with one or more of the remote communication service 918 and data sources 916.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising:
receiving a voice seed;
receiving voice input comprising an audio payload and a voiceprint;
detecting a bandwidth of a network or a signal quality associated with the voice input is under a first threshold;
in response to detecting the bandwidth or signal quality is under the first threshold, converting the audio payload into a text payload comprising textual speech data that represents the audio payload;
transmitting the text payload over the network; and
generating output audio data based in part on the text payload applied to the voice seed.

2. The method of claim 1, wherein converting the audio payload into the text payload is performed prior to transmitting the voice input over the network.

3. The method of claim 1, wherein converting the audio payload into the text payload is performed subsequent to transmitting the voice input over the network.

4. The method of claim 1, wherein generating the output audio data based in part on the text payload applied to the voice seed further comprises:
applying the text payload to a trained large language model (LLM) to generate an augmented text payload; and
generating the output audio data based on the augmented text payload applied to the voice seed.

5. The method of claim 1, wherein the audio payload further comprises a noise signal, and wherein the method further comprises isolating the audio payload from the noise signal based on the voiceprint.

6. The method of claim 1, wherein the audio output data is further based in part on the audio payload.

7. The method of claim 1, wherein the method further comprises:
detecting the bandwidth of the network or signal quality is under a second threshold lower than the first threshold; and
in response to detecting the bandwidth or signal quality is under the second threshold, transmitting the text payload but not the audio payload over the network.

8. The method of claim 1, wherein the voice seed shares one or more characteristics with the voiceprint, and wherein generating the output audio data includes generating a synthetic voice based in part on the voice seed and the voice input.

9. A method comprising:
receiving a multi-media stream comprising audio content, visual content, and chat content;
receiving a first multi-media input comprising an audio input or an image input;
indexing the first multi-media input in a time index and a selected index of one or more content indices;
converting the first multi-media input into a text element that is representative of the first multi-media input;
displaying the text element within the multi-media stream;
receiving a response input responsive to the text element; and
indexing the response input in the time index and the selected index.

10. The method of claim 9, wherein the one or more content indices include a transcript index, an image index, a video index, a chat index, and a tag index.

11. The method of claim 9, wherein the first multi-media input comprises the image input, and the first multi-media input is indexed in an image index.

12. The method of claim 9, wherein the first multi-media input comprises the audio input, and the first multi-media input is indexed in a transcript index.

13. The method of claim 9, wherein the receiving the response input comprises:
receiving an index display selection, the index display selection selecting an index corresponding to one of the one or more content indices, and in response, displaying the corresponding index; and
receiving the response input from a section in the corresponding index.

14. The method of claim 12, wherein receiving the response input further comprises:
receiving a quote selection input identifying a quote element comprising a subset of the text element corresponding to a subset of the audio input; and
indexing the quote element as the response input in the time index and a chat index.

15. The method of claim 13, further comprising:
receiving a response selection including contents of the corresponding index;
receiving a response input comprising one or more of: a responsive reaction input, responsive text input, or responsive multi-media input; and
indexing the response input in the time index.

16. A system comprising:
one or more processors configured to:
receive a voice seed;
receive voice input comprising an audio payload and a voiceprint;
detect a bandwidth of a network or a signal quality associated with the voice input is under a first threshold;
in response to detecting the bandwidth or signal quality is under the first threshold, convert the audio payload into a text payload comprising textual speech data that represents the audio payload;
transmit the text payload over the network; and
generate output audio data based in part on the text payload applied to the voice seed.

17. The system of claim 16, wherein the one or more processors are configured to convert the audio payload into the text payload prior to transmitting the voice input over the network.

18. The system of claim 16, wherein the one or more processors are configured to convert the audio payload into the text payload subsequent to transmitting the voice input over the network.

19. The system of claim 16, wherein the one or more processors are configured to generate the output data based in part on the text payload applied to the voice seed through steps comprising:
applying the text payload to a trained large language model to generate an augmented text payload; and
generating the output data based on the augmented text payload applied to the voice seed.

20. The system of claim 16, wherein the audio payload further comprises a noise signal, and wherein the one or more processors are configured to isolate the audio payload from the noise signal based on the voiceprint.
